(19) United States
(12) Patent Application Publication
(10) Pub. No.: US 2017/0304142 A1
(43) Pub. Date: Oct. 26, 2017

(54) HEPATOCARCINOMA METASTASIS THERAPY APPARATUS AND METHOD FOR USING HEPATOCARCINOMA METASTASIS THERAPY APPARATUS

(71) Applicant: Fusheng Li, Shandong (CN)

(72) Inventors: Fusheng Li, Shandong (CN); An Li, Shandong (CN); Jing Du, Shandong (CN); Xiaomei Yang, Shandong (CN)

(21) Appl. No.: 15/517,907

(22) PCT Filed: Aug. 28, 2015
(86) PCT No.: PCT/CN2015/088330

§ 371 Date: Apr. 7, 2017

(30) Foreign Application Priority Data
Oct. 8, 2014 (CN) 201410524366.9

(51) Int. Cl. A61H 15/02; A61H 1/02; A61H 15/00

(52) U.S. Cl. CPC A61H 15/02; A61H 1/0214; A61H 15/0085; A61H 1/02; A61H 2015/0007; A61H 2201/1269; A61H 2205/08; A61H 2209/00; A61H 2201/105

(57) ABSTRACT

A liver cancer metastasis therapeutic device, consisting of a base plate, a prone support, an abdominal medicine massager, a chain wheel, a rotating wheel and a handheld massager, and being used in a treatment for restoring functions of a whole body; and the therapeutic device is focused on restoring the functions of the whole human body and complementarily performs chemoradiotherapy and surgery for killing cancer cells to treat causes of death, thus significantly reducing a death rate of patients due to metastasis of liver cancers and digestive organ cancers.

### THCHNICAL FIELD

This application is involved with a medical apparatus aiming to treat hepatocarcinoma metastasis by combining medicinal massage, prone horizontal motion and surgery and chemoradiotherapy.

### BACKGROUND

The modern medicine focuses on early discovery, early treatment concerning curing cancers, but over 90% patients with terminal cancers died from metastasis, of which the mortality rate of patients with liver cancer in China accounted for 50% all over the world. The cause of death remains unclear up to now. Doctors can not cure cancers but postpone the development speed. The cancer metastasis including hepatocarcinoma metastasis has become the biggest obstacle, the most key and difficult battle for human beings to cure cancers. Many experts and professors at home and abroad have proposed various suggestions and views as follows:

Bases and clinics of hepatocarcinoma metastasis and recurrence was compiled by TANG Zhaoyou as the director of the liver cancer research institute of Fudan University and published by Shanghai science and technology education press in January, 2003 (page 16, 199). Look into the future: studies on hepatocarcinoma metastasis and recurrence mainly focus on the following tasks: \textcircled{1} genome and proteome related to hepatocrcinoma metastasis; \textcircled{2} correlation between organisms (especially immune function) and dynamic changes of biological characteristics of hepatoma carcinoma cells; \textcircled{3} studies on effective intervention of hepatocarcinoma metastasis by inhibiting cancer cells and improving organisms' immune functions. The immunotherapy can only play its role maximally by combining other therapeutic means including surgery, radiotherapy and chemotherapy. Elimination and reconstruction was compiled by TANG Zhaoyou and published by Shanghai Science and Technology Press in August, 2011 (preface, page 35 and 156). The author has been engaged in studies on hepatocarcinoma metastasis and recurrence for nearly 20 years. According to his findings, though various cancers have their own “individualities”, the “universality” is playing a dominating role. From the perspective of philosophy, unity of opposites, interdependence and conversion of the opposite etc will definitely provide new thoughts and visions for anti-cancer strategies. Though the author is not engaged in philosophy, but he proposed perhaps a anti-cancer road with Chinese characteristics can be found in the dialectics. The generalized intervention will play a crucial role in the anti-cancer battle in the future. Particularly, based on possible tumor elimination, sometimes no intervention is the best treatment. The author held that patients shall do nothing after the (liver cancer) radial surgery.

The fourth edition-science and technology change lives of Science and technology daily on Nov. 26, 2013; the secretary general of Chinese anti-cancer association LIU Duanqi held that single medical technologies are only supporting roles for cancer patients. For example, surgeries in intermediate and advanced stages, improvement of radiotherapy and appearance of new technologies etc are in a subordinate position (about 10%-20%). The medical technologies only contribute 5 years among 30 newly added lifetimes of American people in recent 100 years. The technological level of China is almost the same as that in America. concerning treating terminal cancers. At present, medical science is powerless. The eighth edition-medicine forum “a new medical system integrated with traditional Chinese and western medicines” of Health Journal on Jul. 5, 2010; professor Wang Ximin from the clinical medicine college of Jiamusi University in Heilongjiang held that the prospect of modern medicines lies in integrated theories of traditional Chinese and western medicine; once theoretical problems are solved, clinical application will work out accordingly. Science and Technology Daily reported on May 8, 2004 that some American researchers held the cause for incurable cancer lies in too many changes, which prevent human beings from finding a simple therapy. Reference News reported on Aug. 1, 2013: the chief medical officer of the American Cancer Society Otis. Brawley said: “we need to use the definition of cancers in the 21st century to replace that in the 19th century”. Contemporary Health Journal published on Jul. 12, 2001 that Hippocrates, hailed as “the father of western medicines” once said: “nature is rehabilitees of diseases. Doctors would be gods for knowing about philosophy in the ancient Greece in the 5th century BC”.

The current technology cancer therapy apparatus was approved on Jun. 29, 2011 with the national application patent number of ZL200610069987.8; PCT (international patent PCT/CN2007/003135) was approved on Jul. 27, 2012 with the Japanese application patent number of 5047301; Cancer Metastasis Therapy Apparatus was approved on Mar. 27, 2013 with the national patent number of ZL201220434659.4. The principle and method of the treatment of major diseases proposed in this patent specification were as follows: the integral medical model based on combined modern philosophy and modern science that are developed from ancient Chinese philosophies with theories of traditional Chinese medicines held that the global factors based on symmetry of structures and functions play a crucial role in cancers. In this sense, cancers shall be treated globally so as to achieve expected objectives, which have essential differences with the modern medicine that treats major diseases dominant by structures based on modern science as well as the empirical medicine lacking of sufficient philosophy theories.

Deficiencies of Existing Technologies.

The body structure is designed for horizontal motion, while prone horizontal motion is the foundation for human beings to improve general functions so as to adapt to life existence, of which crawling exercises and swimming can help improve abdominal digestive functions. Thus, it can be used to treat metastasis of liver cancer and cancers related to gastrointestinal digestive systems. Lung cancer metastasis therapy apparatus was approved on Dec. 25, 20013 with the patent number of ZL201320254913.7, which adopts supine horizontal motion but with little space for abdominal exercises due to the action of gravity. Thus, it is not beneficial to improve abdominal digestive functions or treat metastasis of liver cancer and cancers related to gastrointestinal digestive systems.

SUMMARY OF THE APPLICATION

This application intends to recover body functions through holistic medicine massage, abdominal medicine massage, prone crawling exercises and prone swimming by assembling the base plate, prone bracket, abdominal massager, sprocket drive, runner and hand massager into a global device aiming at insufficient function recovery of existing technologies in treating liver cancer metastasis that leads to systemic functional diseases or even death. This application adopts hand massagers and chemoradiotherapy in the cancerometastasis lesion stage to conduct the holistic therapy dominant by killing cancer cells and supplemented by recovering functions aiming to control metastatic lesion, alleviate symptoms and delay lesions. The existing technologies only carry out the palliative treatment without any function recoveries in the death stage of liver cancer metastasis. The body function lesion is the main cause of death, while the system cancer metastasis lesion is the secondary cause of death. Therefore, this application conducts the holistic treatment dominant by recovering body functions and supplemented by killing cancer cells aiming at regions with diseased abdominal digestive functions and decreased circulatory and respiratory functions so as to prevent global function lesion and reduce the mortality rate.

In order to achieve the above mentioned objectives, the technical proposal of this application was as follows: a hepatocarcinoma metastasis therapy apparatus, composed by a base plate, prone bracket, abdominal massager, stype, roller bracket, drive axle, chain wheel, chain, rotary disc, pedal, runner bracket, adjustable-speed motor and hand massager, is used to treat hepatocarcinoma metastasis dominant by recovering body functions and supplemented by killing cancer cells together with chemoradiotherapy; its characteristics lie in as follows: install the prone bracket in the middle of plates; install the abdominal massage with medicines on the prone bracket; fasten the roller bracket on the base plate and install the drive axle and chain wheel; the rotary discs are fastened on two ends of the drive axle; the chain wheel transmits together with the chain; the runner bracket is fastened on two ends of the front of the plate with the runner on it. Patients can enjoy massage by lying on the abdominal massager with hands holding the rotary disc and feet fixed by pedals. Further, patients can conduct passive crawling exercises by starting the revolving chain on the roller bracket. Patients can also carry out active crawling exercises without using the motor but some minor swinging back and forth. More importantly, patients can continue with leg movement by loosening the rotary disc and holding the runner. After exercises, patients or doctors can conduct holistic medicine massage with hands holding the massager to transport and replenish the mechanical energy, heat energy and chemical energy.

The apparatus in this application is mainly used to recover digestive functions and treat decline in muscular movement, blood circulation, respiratory immune and neurological functions etc, which can also be used to treat metastasis of liver cancer, esophagus cancer, gastric cancer as well as rectal cancer and colon cancer. Proper adjustments may be required aiming at different lesions and regions, but the principle and objective are consistent.

In order to disclose this discovery, this application described the principle and technology of treating hepatocarcinoma metastasis lesion in details.

Principle of Treatment

One, the human body function lesion is the main cause of death of patients with cancerometastasis;

1, Decline in Human Body Functions is the Reason for Limited Human Longevity and Incurable Diseases.

Functions and structures depend on each other in the development history of life evolution. The life structure will break up if without normal functions. According to the prediction equation of the theory of “natural coefficient” that is widely acknowledged by the world, a British biologist Bafeng reckoned that the maximum life span of general mammals is equivalent to 5-7 times of that in the growth period, while human beings' growth period is usually completed between 20-25 years. Thus, the maximum life span of human beings shall be between 100 and 175 years. The reality indicated that cattle, horse and other animals can achieve their natural life spans, while human beings can only live up to a half of their natural life spans. Anyway, human beings are the only animals that can not live up to their natural life spans. Based on that, scientists made conclusions as follows:

\textcircled{1} Changes of mode of motions; human beings replace horizontal motion by vertical movements, which increases heart and brain s vascular burden, reduce circulatory functions and lead to hypertension and heart cerebrovascular diseases. Thus, the vertical movement brings the most serious side effects.

\textcircled{2} Changes of respiratory manners; except for human beings, all other animals adopt abdominal respiration; the vertical movements lead to thoracic respiration, which causes long-term idle of most of lung cells that will lose vitality and reduce vital capacity.

\textcircled{3} Changes of digestive functions; four limbs, lumbar spinal cord and abdomen will move together in the horizontal motion to promote peristalsis of gastrointestinal tracts and improve functions of digestive organs, while splanchnoptosia would be occurred due to the action of gravity in the vertical motion, which then leads to weak gastrointestinal and digestive functions.

Metabolism is the foundation of vital movement. The vertical motion of human beings not only bring side effects including decline in body functions (including circulatory, respiratory and digestive functions), but cause relatively short life longevity and incurable diseases, of which heart cerebrovascular diseases caused by decline in circulatory functions have the highest mortality, while the lung cancer caused by decline in respiratory functions as well as digestive cancers such as liver cancer, gastric cancer, esophagus cancer, pancreatic cancer and rectal cancer etc caused by decline in digestive functions are main causes of death of patients.

The lesions of digestive system functions as well as decline in circulatory, respiratory, neurological and immune functions are main influencing factors for the development of lesion in the hepatocarcinoma metastasis. If without treatment, cancer cells can not be killed, which will promote lesion diffusion, metastasis and recurrence and finally develop into body function lesions, failed metabolism and then death. The human body function is mainly involved with the mechanical energy and heat energy. The muscle and liver will produce most of energies. More importantly, most of energies consumed by organisms will be dissipated via the form of heat energy with only small part in the form of mechanical energies. That is, external works completed by skeletal muscles; energies will be consumed and then replenished in the metabolic process. That's how life continues.

2, Human Body Function Lesions are Death Factors in the Cancerometastasis Process.

The basic vital signs lie in metabolic activities. Lesions in metabolic functions will endanger lives. There is no isolated part in the viable organisms. The function lesion is the cause of death, while the structure lesion will accelerate this process. Functions and structures depend on each other.

According to evidences of ancient and modern medicines, human body function lesion is the main factor to cause final death. Just as the medical scientist XU Lingyi in the Qing Dynasty said in Origin of Medicine: “if with no injuries on vitality, patients will not die even with diseases; if with injuries on vitality patients will die even with minor diseases.” The author of liver cancer metastasis (America, translated by Song Yong and Shen Xiaokun and published by People's Medical Publishing House on June, 2011; page 284, edition 1) named Venkeshwarkeshamouni from the University of Michigan wrote in the conclusion part: “though chemoradiotherapy and other various iatrotechnics can kill cancer cells and eliminate and control obvious effects caused by metastatic lesions, it remains unclear why patients can not survive after controlling most of micrometastatic lesions, because most of patients who received partial treatments died from progression of systemic diseases rather than partial failure. It is named as vitality or injuries in the traditional Chinese medicine, as well as progression of systemic diseases or systemic functional lesion in the western medicine. That is, lesions in circulatory, respiratory and digestive functions etc. It can be seen from the above descriptions: light or heavy lesions and controllable metastasis or not are not the main causes of death. The traditional Chinese medicines hold if with normal body functions, patients even with heavy diseases will not die. After all, there are many patients who survive with cancers. The modern medicines hold “structures determine functions”. It is a therapy with both gains and losses by only conducting structural anti-damage treatment without recovering functions. The structural treatment can only alleviate symptoms without main functions on death. The functional treatment can replenish energies and maintain survival with a role of getting a permanent cure and main functions on preventing death. Though the existing technologies can control cancer metastatic lesions and alleviate symptoms, it would be harmful for patients without functional treatments on lesions, because lesions around focus will develop into other systematic functions, which then leads to systemic functional lesion or even death.

3. According to philosophy theories, the opposites in the unity are completely equal without any particular order of importance. In the things development process, though strength of both parties can be divided into major one and minor one, they are restricted by unity with limited range and way of balance of power. Structures and functions in the human body depend on each other, which determine life existence and development. If separated, it can only produce partial quantitative changes without overall qualitative changes. That is, separation means death. The cancerometastasis conforms to the overall law development instead of structural or functional parts. Though structures and functions are without any particular order of importance concerning property and composition, their order of importance will be alternated due to times, places and events in the changing process; structures play a leading role based on unchanged functions, while functions play a leading role based on unchanged structures. Those two aspects will restrict each other in the lesion process. The casual relationship of lesions refers to an essential connection of another phenomenon that is caused by one phenomenon including time series. Therefore, after structural treatment that is dominant by killing cancer cells, patients must receive some functional treatment that is dominant by recovering body functions aiming to reverse lesion development trends.

Based on the principle and method of the treatment of major diseases combined with philosophy and science, this application drew schematic diagram of principles of production and development of hepatocarcinoma metastasis, schematic diagram of principle and technique of treating hepatocarcinoma metastasis and schematic diagram of cause of death of patients with cancerometastasis as well as changing rules of the death process. It can be seen from the above mentioned diagrams that every process and stage of the development of liver cancer metastasis is some results of quantitative and qualitative changes of structures and functions. The philosophical factors in the traditional Chinese medicine can integrate with scientific factors in the western medicine in the pathology area.

Further, it can be seen from schematic diagram of principles of production and development of hepatocarcinoma metastasis that the terminal cancer, namely different layers of qualitative changes, is caused by lesions of organic structures and system functions, which will then lead to systemic structural lesion and cancerometastasis. The holistic therapy dominant by recovering system functions and supplemented by conducting anti-damage of organic structures in this stage can reverse lesions and guard against cancerometastasis. The systemic structural lesion will not be occurred if with normal system functions. The cancerometastasis, namely different layers of quantitative changes, is caused by lesions of system functions and structures, winch will lead to systemic functional lesions. The holistic therapy dominant by anti-damage of systemic structures and supplemented by recovering system functions can eliminate or control lesions of cancerometastasis, alleviate symptoms and delay systemic functional lesions, but it can not reverse the necessary trend towards systemic functional lesions. As one of death factors, the systemic structural lesion and body function will restrict each other. This stage will have different layers of qualitative changes and then lead to the next death stage. The holistic therapy dominant by recovering body functions and supplemented by conducting anti-damage of systemic structures in this stage can reverse lesions and prevent death occurrence. The higher integrity of combined structural treatment and functional treatment means higher curative effects. The holistic therapy does not have side effects of treatment, because side effects in the structural treatment can be solved by the functional treatment, while side effects in the functional treatment can be solved by the structural treatment. Other therapy methods and construction can also achieve objectives of this application during the etiological therapy on the unity combined with structural and functional treatments.

Two, human body function recovery is the main treatment to decrease the mortality rate of patients with cancerometastasis obviously;

The existing technology cancer therapy apparatus (national application patent, ZL200610069987.8) proposed the principle and method of the treatment of major diseases in its patent specification. It held decline in functions is the cause of cancers, which also leas to its incurable nature. The paragraph [0042] of page 10 of the patent specification pointed out clearly: “an oxygen-inhaling horizontal locomotorium is needed to recover respiratory functions and promote blood circulation when using cancer therapy apparatus on the respiratory system as well as the digestive system such as the liver, gallbladder, intestine, stomach and pancreas etc. Further, the visceral massage can recover functions of digestive systems. Please see specific operations in Cardio-cerebro-vascular Diseases Therapy Apparatus (application number: 200610069553.8. Therefore, the principle of the treatment of Hepatocarcinoma Metastasis Therapy Apparatus has been ascertained as a part of the holistic treatment in cancer systems in 2006. More importantly, the Cardio-cerebro-vascular Diseases Therapy Apparatus won the national application patent ZL200610069553.8 on Dec. 8, 2010; the lung cancer metastasis therapy apparatus won the national patent ZL201320254913.7 on Dec. 25, 2013.

The above technologies used supine horizontal stretching exercises to recover circulatory and respiratory functions, but they can not be applied to recover digestive functions. This application adopted combined prone horizontal stretching exercises to recover digestive functions, which is suitable for the treatment of cancerometastasis of digestive systems such as the liver, stomach, gallbladder and pancreas etc. The specific mode of action is as follows:

1. When supine, the abdominal digestive organs shall have a rest instead of conducting stretching exercises and massages, because abdominal organs will be in an overlying state due to the action of gravity without any space for stretching. The digestive organs, especially intestinal organs in the hypogastric region will be squished due to insufficient motion space at the time of doing horizontal stretching exercises and abdominal massage, which then further lead to side effects due to structural strains. Of course, it can not achieve effects of recovering digestive functions. When prone, blood, lymph and viscera will experience changes due to the action of gravity, which can help to improve uneven blood distribution and allow the heart, lung and liver etc to be in a relaxing state with enough stretching space. At this time, the horizontal stretching exercises and abdominal massage can eliminate blood stasis, promote organ structural motion and improve the curative effect. The prone horizontal stretching exercises are the survival instinct of human beings, similar to crawling and swimming etc, which has obvious curative effects aiming at decline in functions caused by long-term vertical motions. Besides, the exercises are characterized by a wide range of motion and safety. It is suitable for the elder, pregnant women and kids without hurting joints but strengthening cardiopulmonary and digestive functions.

2. According to the relation between the mechanical property and external conditions of biological tissues, the abdominal organs belong to passive tissues, which will be greatly affected by supine and prone positions. Four limbs and dorsal muscles belong to active tissues, which will not be greatly affected by supine and prone positions.

3. The prone horizontal stretching exercise can conduct “internal massage” inside the abdominal organs due to the action of gravity. Further, an electric massage mattress is installed under the abdomen to promote mutual functions of “internal massage” and “external massage” so as to improve abdominal digestive functions. Meanwhile, four limbs' horizontal stretching exercises and abdominal breathing exercises can improve cardio-pulmonary functions obviously.

4. Many patients with liver cancers regained their health by conducting some treatments dominant by recovering the human body's layer functions and the exercise therapy that is supplemented by killing cancer cells and controlling cancerometastasis aiming at system layers including the horizontal stretching exercise and swimming etc. The director of Liver Cancer Research Institute of Fudan University Tang Zhaoyou held in the preface of Chinese-style Anti-cancer-Wisdom in Sun Zi Bing Fa (Shanghai Science and Technology Press, edition 1 in April, 2014): (page 145) “swimming inhibits cancer” is a new idea. The author dared not to say that in the past until now because of findings of experiment researches. After the tumor resection (page 145), swimming can inhibit some remaining limited cancer cells by improving anti-cancer abilities. (Page 212) Swimming has good anti-cancer effects. An Indonesian patient with a liver cancer operation 10 years ago intended to find the author. The patient is in ruddy health. He said the examination results are good. I asked about his life. He said: “I am swimming every day”.

Stretching is the instinct of human beings. The stretching and relaxing horizontal motion such as crawling and swimming) can reduce and eliminate side effects caused by vertical motion. The breathing exercise, ointment massage, Qigong, guidance, massage as well as acupuncture and moxibustion etc in the traditional Chinese medicines have thousands of histories with a common characteristic: breathing and oxygen supply. The combined stretching exercises and self massage can prevent diseases and improve curative effects via the holistic treatment.

Though only few patients were cured, its recovery principle and method follow the natural law, which represents a correct treatment direction. It is characterized by feasibility for promotion and development as well as a possibility for recovery by conducting theoretical analysis on the related experience and increasing strength, range and means in the treatment dominant. Based on that, most of patients with liver cancer metastasis can be cured to decrease the morality rate obviously. It only takes 10 minutes to receive a systemic recovery function treatment by using new technologies with less than 200 RMB, which will be cheaper and more convenient for self-therapy in the home. Perhaps, it would be difficult for technicians in the cancer therapy field who mainly use existing technologies to kill cancer cells to think of using the treatment dominant by recovering body functions to reduce the mortality rate of patients with liver cancer metastasis mentioned in this application. Meanwhile, this application also breaks down contempt and prejudice that the recovery function therapy is only an adjuvant treatment in treating cancer metastasis. The existing technologies hold cancer metastasis can not be cured and the death of patients can not be stopped. The symptoms can only be alleviated via the palliative treatment. Such view without guidance of philosophy theories does not confirm to the natural law but with one-sidedness.

Three, Cause of death of patients with cancer metastasis as well as changing rules of the death process;

Why over 90% patients with cancer metastasis die eventually? Why many patients whose metastasis has been controlled and eliminated still die from systemic functional lesions? Why the existing technologies can not stop death? How to prevent patients from death?

1. Cause of death of patients: life lies in motion instead of in an anatomic form; that is, interactions among philosophy theories. The recovery function therapy in the medicine field is based on philosophy theories with emphasis on determining the therapeutic way and controlling disease development trends. The structural anti-damage therapy is based on scientific technologies aiming to alleviate disease symptoms and delay lesion development. They, as two kinds of different medicines, depend on each other. Over 90% patients with cancer metastasis will die from body function lesion in the high-level range. The existing technologies will be restricted by high-level functions concerning the structural anti-damage treatment in a low level. Further, they can not stop death. It can be ascertained that the therapeutic goal and direction may be wrong, or else it is impossible to have such wide universal results. The modern medicine holds the death of patient is caused by body structural lesions due to balance of power of structural damages and anti-damages. The treatment dominant by chemoradiotherapy and molecular targeted drugs to kill cancer cells and eliminate metastasis can stop death occurrence. However, the clinical therapy verified that the structural lesion is not the death factor. Functions are prior to structures in the death process. Once the life function stops, life structure will collapse accordingly. The later body structural lesions do not have any therapeutic significance. Thus, the systemic functional lesion is the death factor. The structural treatment can not replace the functional treatment, but the holistic therapy combined with the structural treatment and functional treatment can ascertain the correct direction so as to save most of patients with cancer metastasis.

2. Changing Rules of the Death Process of Patients

Changes of fundamental natures of things refer to a leap from one qualitative form to another qualitative form. As the old saying goes: “things will develop in the opposite when they become extreme.” The cancerometastasis lesion started from functional lesions and then led to structural lesions. Based on that, a new functional lesion begins. Such repeated development process between functions and structures has universal significance. Aiming at this, we drew the Schematic Diagram of Cause of Death of Patients with Cancerometastasis as well as Changing Rules of the Death Process to clarify the changes of the death process by combining causes of death. The main therapy and adjuvant therapy aiming at cancer metastasis depend on each other but with differences in their strength and range. The main therapy aims at major lesions in this stage, while the adjuvant therapy aims to stabilize minor lesions so as to guarantee a smooth treatment. According to the law of quality and quantity, two different changing forms including “structures determine functions” and “functions determine structures” play leading roles in different stages in the lesion development process alternately, of which the form of “structures determine functions” is applied in the cancer metastasis lesion stage with the same layer of quantitative changes, while the form of “functions determine structures” is applied in the death stage of cancer metastasis with different layers of qualitative changes.

The system function lesion in the multiple metastasis stage refers to a main functional lesion among the cardiovascular circulation function, respiratory function and digestive functions etc with others not diseased but in a decline state. When all main functions are in a diseased state, it means systemic functional lesion. At that time, patients have entered into the death stage. The process from cancer metastasis to death refers to decline in main functions and then lesions of cardiovascular circulation function, respiratory function and digestive function etc. The patients can survive for years or months sometimes. The body functions of most of patients are still available. The holistic therapy dominant by recovering functions and supplemented by controlling metastatic lesion in this process can guarantee no lesions of most of main functions. In this way, patients with heavy diseases will not die eventually.

Contents relevant to therapy techniques:

Four, recovery function therapy in the liver cancer metastasis

The recovery function therapy can improve patients' survival state and prolong lives, which is a symmetrical component in the holistic treatment. The recovery can be divided into two parts that is dominant by recovery functions and supplemented by structural anti-damages respectively.

The recovery function therapy in this application refers to a treatment that is dominant by recovering digestive function as well as related circulatory function, respiratory function and immune function. The specific contents are as follows:

1. Therapies and Technologies Dominant by Recovery Functions

\textcircled{1} Oxygen-inhaling horizontal stretching exercises: human muscles have two basic functions including the stretching ability and extensibility. Various fitness exercises such as walking, jogging, cycling etc can strengthen muscular contraction, while horizontal stretching exercises can relax muscles and alleviate tensions. Therefore, a human body can maintain healthy based on those mentioned above. The upper limb movement of horizontal stretching exercises in this application can strengthen digestive and respiratory maneuvers, prevent blood stuck in lower limbs and decline in cardiac outputs. The forward movement can strengthen arm and dorsal muscular contraction force, while the back movement can relax muscles with balanced exercises. The pedal wheels can increase the contraction force of lower limbs, while the horizontal prone position can relax lower limbs. The rise and fall of diaphragm muscles as well as relaxation and contraction of abdominal muscles of horizontal stretching exercises have good internal massage effects on the gastrointestinal tract and liver etc, which can further alleviate blood stasis, improve and strengthen blood circulation and secretion of digestive juice, promote digestion-absorption functions, increase synthesis of plasma-albumin and help the liver to detoxify and excrete poisonous substances. Meanwhile, the range of motion of diaphragm muscles can be increased by 2-4 times than that of normal people, which can improve oxygen inhaling and vital capacity, help with gas exchange and increase respiratory functions. The blood flow rate of muscles in a relaxing state will be increased 10-16 times compared with that in a stiff state. Thus, the muscle blood vessels will be forced to conduct contraction due to vertical motion of human bodies aiming to improve the high blood pressure so as to strengthen circulatory functions. The immune functions are closely related to circulatory, respiratory and digestive functions, which can be improved at the same time as parts in the human body function structures. The effect of single application is rather limited. Oxygen is the first energy needed by human tissue cells. The decline in cellular oxidation of 35% can aggravate the development of cancer. The key of the oxygen therapy lies in patients' exercises. The oxygen inhaling apparatus, as one of the existing technologies in this application can allow patients to inhale oxygen actively at the time of carrying out stretching exercises. The strengthened blood circulation can allow various tissues of the body to utilize oxygen so as to enhance PAO and improve the physique status. Just as Reference News reported on May 5, 2012 [American Daily Scientific Website on May, 3]: researches indicated that cell hypoxia may be the main reason for metastasis; once confirmed, it may reverse the traditional cancer therapy and explain why cancers diffuse quickly with resistance to drugs in 3-6 months.

\textcircled{2} Massage in the Prone Gorizontal Motion

The smooth muscles in the digestive tract have same characteristics as common muscles; that is, excitability, conductivity and contractility; further, they are sensitive to chemistry, temperature and mechanical tension. The muscles of digestive tracts can complete digestion through contraction and relaxation. The digestive function is closely related to metabolism all over the body. The muscles will be relaxed after massage with their blood flow rates increased by 10-16 times compared those in a tension state, lymph flow increased by 7 times and the opening number of blood capillaries per square millimeter on the section of muscles increased from 31 ones to 1,400. Further, it can improve microcirculation to deliver drugs to the endemic areas for further absorption. The prone bracket is installed on the base plate in this application. The abdominal massager is installed on the bracket, which can conduct medical massage on the abdomen during horizontal crawling and swimming. The digestive organs such as the liver, stomach, intestine, pancrea, gallbladder and kidney will be moved rhythmically with “internal massage” such as sudden reach and distance, contraction and relaxation etc. Besides, it will change the blood, lymph and cerebrospinal fluid circulation as well as viscera positions. Such “internal massage” is completed by various viscera due to the action of gravity. The external massage can not achieve such depth or effects. The combined abdominal massager and “internal massage” can improve digestive functions. The hand massager, as one of existing technologies in Cancer Therapy Apparatus, can conduct muscle massage, cutaneous penetration and electrotherapy to recover neurological functions. The local and systemic medical massage can strengthen body functions. The improvement and combination among the therapeutic goal, area and effect of apparatuses related to the prone horizontal motion and abdominal massager together with recovery systemic functions have substantial therapeutic significance.

\textcircled{3} Symptomatic Treatment in the Recovery Function

The symptomatic treatment aims at liver cirrhosis and ascites. It can be seen from the Schematic Diagram of Principles of Production and Development of Hepatocarcinoma Metastasis: the nature of diseases is determined by mutual restriction of local structural lesions as well as the surrounding functional lesions. The anti-damage therapy shall be carried out on the structural diseased regions (lesions). The traditional Chinese medicine aims at eliminating pathogen including promoting blood circulation to remove blood stasis as well as clearing away heat and toxic materials; the recovery function therapy shall be conducted on the surrounding systemic functional diseased region. The traditional Chinese medicine aims at strengthening the body resistance such as tonifying spleen and regulating vital energy as well as nourishing the liver and reinforcing the kidney etc. The oral drugs can not be distinguished easily, but massage and cutaneous penetration can achieve localized treatments. The cutaneous penetration aims at the whole body or the depth of tissues, which is quite different from oral medicines. Preparation of topical solution: the Chinese medicines can be applied by adding the corresponding contact agent and permeation-promoters after stirring evenly based on immersion liquid or apozem prepared by oral and unguent medicine (for external use). The Chinese patent medicines such as the active oil and safflower oil as well as some western medicines such as nitroglycerin and isosorbide dinitrate can be applied on skins. Therapeutic method: smear some liquid on the treated area; hold the hand massager to move back and forth on it. The curative effect is superior to the single massage and herbal medicines for external use.

The liver cirrhosis is the foundation of liver cancer, which is mainly represented by liver function damages as well as portal hypertension. The common complication includes upper gastrointestinal hemorrhage, hepatorenal syndrome, ascites and primary hepatic carcinoma etc. The localized therapy, or called as the definitive therapy has relatively high curative effects. The principle of the treatment of liver structural lesions aims to improve and rebuild microcirculation that is destroyed by liver fibrosis, promote liver cell reactivation and cytothesis and recover liver functions. Therapeutic method: smear medicines with functions of promoting blood circulation to remove blood stasis as well as topical solutions with functions of clearing away heat and toxic materials on the diseased region; smear the paste with functions of reliving water retention with hydragogue on the umbilical region; patients with cirrhotic portal hypertension can smear the Qitou Xiaogu Plaster around the umbilical region; patients with posthepatitic cirrhosis can smear the related Chinese plaster on the Qimen and Shenque acupoints; the region, solution and plaster will be varying for different patients. Then, the hand massager can be applied to move hack and forth on related regions every 3 minutes.

Upon the completion of the above mentioned therapy, the Chinese medicine supporting therapy is used to recover functional lesion of the digestive, circulatory and respiratory systems. The external used drugs with functions of tonifying the spleen and regulating vital energy, nourishing the liver and reinforcing the kidney can be smeared on the back or the whole abdomen. Further, the massager can be used for further therapy every 3 minutes. It can be conducted every two days if with repeated regions. The holistic therapy can be carried out every day with 15 times as a course of treatment.

Some medicinal liquid and ointment for massage and external use are as follows:

Cirrhosis Chinese medicine paste prescription is originated from “Shanghai Journal of Traditional Chinese Medicine” 1991 volume 3. Adaptive indication is cirrhosis after hepatitis, (repeated massive haemorrhage patients caused by portal hypertension shall not be the objects of observation) drugs are composed of Chinese medicines like Astragalus, Angelica, Rehmannia, Chinese thorowax root, peach kernel and common burreed rhizome.

Hydragogue method paste prescription is originated from “Shaanxi Journal of Traditional Chinese Medicine” 2003 volume 7. Adaptive indication is the disease for cirrhosis ascites, drugs are composed of Gansui power, Euphorbia, Daphne and borneol 10 grams respectively. Preparation method is made into powder, over 100 mesh sieve with ginger juice into a paste, in the conventional use of diuretics based on the application.

Omphalocele paste prescription is originated from “Chinese Journal of Integrated Traditional and Western Medicine” 2008 volume 7. Adaptive indication is portal hypertension, drugs are composed of Raphani, Stephaniatetrandra, pberetima and fructusamomi (proportion: 10:10:5:5).

Drug massage and external treatment featuring targeting and rapid force without side effects, are suitable for the treatment of sudden changes in the disease, before the Tang Dynasty, it was equal to external treatment (physical therapy belongs to external treatment) and internal treatment (to be taken orally).

Supplementary Treatment of Killing Cancer Cells Structure Anti-Injury

As there are already existing metastatic lesion and some small amount of cancer cells in the patients in hepatocellular carcinoma metastasis in the digestive system and the relevant parts, and to restore digestive function and to promote related circulation and respiratory function at the same time will promote the proliferation and proliferation of cancer cells, so at the same time with the recovery function, it is necessary to carry out the treatment of killing the cancer cells to cooperate with the recovery function.

Mainly in the following ways: cancer-related acupoint injection, tender point microcirculation disorder injection, intramuscular injection, indirect lymphatic subcutaneous injection (the injection sites make drugs do not enter the blood vessels but into the lymphatic system), respiratory administration, transdermal administration.

Selection principles in acupoint injection: \textcircled{1} Disease in Zang and Fu, acupuncture on Back-shu point, supplemented by He-sea point, Ququan for liver cancer. \textcircled{2} Combined with anatomical sites, acupuncture in contiguity. Such as liver cancer mainly focuses on Ganshu, ascites patients focus on Shenshu or Pang kuangshu point, patients are loss of appetite focus on Tsusanli and jaundice patients focus on Ex-LE6 point. Respiratory administration is of anticancer drugs into aerosols, using in abdominal breathing exercise with horizontal direction. Transdermal administration of anti-cancer drugs shall be added to some corresponding contact agent and permeation-promoters.

In the acupuncture point anti-cancer injection, the ways of injection and injecting are as follows:

\textcircled{1} Aconite injection, daily intramuscular injection for 1-2 times, 1-2 ml each time, no adverse reactions, the clinical application of gastric cancer liver metastases and late liver cancer. \textcircled{2} Polyporusumbellatus polysaccharide can improve the immune function and enhance the effect of chemotherapy on liver cancer, 40 mg each time, 1-2 times a day with intramuscular injection. \textcircled{3} HerbaHedyotis is a kind of heat-clearing and detoxifying drug, better do injection in Benpin point with a certain effect for liver cancer. \textcircled{4} Methotrexate (MTX), twice a week, 10 mg each time, dissolving with 4 ml of Chinese herbal medicine, the total amount of 300 mg as a course of treatment.

While the transdermal drug delivery technology can be used to get recovery function and kill cancer cells, many of the macromolecules in the prior art including traditional Chinese medicine are difficult to pass through the cuticle of the skin, resulting in a small dose of transdermal administration, only can increase the dose by increasing the area of transdermal administration mainly, Targeted treatment need to increase the number of drugs in a small area and use macromolecules and traditional Chinese medicine. The present application can be applied to the product of the prior art “uremia skin dialysis treatment device”, patent number ZL201220539707.6, which used the combination of crush and transdermal drug delivery and ultrasonic transdermal administration, in which ultrasonic air can make macromolecules through the skin stratum corneum. Pressing the friction input mechanical energy and thermal energy to improve the microcirculation, promote drug absorption, thus solving the above problems, is the local treatment for local transdermal administration.

The present application also uses a hand-held massager to carry out systemic anti-cancer drug massage on the patient, and the massage time is 8 seconds in each part of the body, and the whole body massage is completed within 8 minutes. After treatment, the skin can be washed with warm water; the total area of adult skin is about 2 square meters and about ⅓ of the body's blood can flow through the skin; body massage can make anti-cancer drugs through the skin into the blood circulation, play a systemic treatment, and at the same time enter the mechanical energy, heat, enhance blood circulation, lymph circulation, promote drug absorption, restore physical fitness, eliminate injection of chemotherapy side effect.

Here are several anti-cancer transdermal absorption drugs: cyclophosphamide, vincristine, fluorouracil.

\textcircled{1} An anti-cancer drug that absorbs transdermal transdermal (including compressive transdermal absorption); according to the characteristics, the cyclophosphamide, vincristine can be added to the corresponding coupling agent and applied after stifling evenly. For example, add fat-soluble drugs to lanolin, formulated into ointment or cold cream; water-soluble drugs dissolved in water, Chinese herbal medicine can be made into immersion or decoction.

Reference: “Clinical treatment of common malignant tumors” editor Liu Sihai, etc., Military Medical Science Press, January 2010 first edition 210 pages, 211 pages. “Principles and Applications of Ultrasound Treatment” editor WANG Zhibiao, Nanjing University Press, June 2008 first edition 244 pages, 245 pages.

\textcircled{2} Because of gastrointestinal irritation side effects, the application of Fluorouracil chemotherapy is limited. Topical and the amount: 1% -10%, ointment, film agent, osmotic application of local smear, 2 times/day, 15 days for a course of treatment, the whole body massage once two days, also, if it produces stimulating reactions, such as erythema, blisters, pain, you should pay attention to protect skin lesions around the healthy skin. Hand-held massager with a cloth to protect the skin, generally do not have side effects on the skin. Fluorouracil cream is mainly made of fluorouracil, white petrolatum, liquid paraffin, glycerol, cetyl alcohol, distilled water and other after heating and inciting and the temperature is 70-80° C., during which, if there is no raw materials, the fluorouracil can also be used instead of tablets. Detailed prescription, method, refer to “new drug manual” WANG Lei and other editors, Shandong Science and Technology Press, September 1996 first edition, 154 pages-155 pages.

Tang Zhaoyou academician mention edon page 145 of the book “elimination and transformation of both”: A patient with extensive lung metastases after a liver cancer was treated with 250 mg of fluorouracil (this very small dose) after discharge. Did not expect six months later, the patient was with red face and chest perspective effect was very good, the patient said one needle of chemotherapy each next day had no side effect, and be rided a bike every day for 3 hours and took oral administration of cough medicine”. Although the above is a case, it is consistent with cancer metastasis of the latter part of the overall treatment direction based on the structure of anti-injury secondary recovery function, and made a universal significance. Refer to the way of next day injection of fluorouracil 250 mg, in the case of patients with a small amount of anti-cancer chemotherapy drugs, give patients the body drug massage (drug refers to the spleen qi, blood circulation to restore functional topical drugs) and oxygen level stretching exercise to enhance systemic function, which is the correct treatment to improve the ability to kill cancer cells, eliminate the side effect of systemic chemotherapy, significantly reduce the mortality of patients, but also a treatment with low cost and high efficacy that lung cancer metastasis, liver cancer metastasis patients can use.

V. Resistant to the Treatment of Liver Cancer Metastasis

Structural anti-injury treatment is divided into two parts: structural anti-injury-based treatment and recovery function-based treatment.

1. Digestive System Structure Anti-Injury-Based Treatment is the Main Anti-Injury Treatment.

Liver cancer metastasis in the digestive system and related system structural damage, refers to the primary liver cancer lesions, and intrahepatic metastasis and extrahepatic blood transfer to the lung, adrenal gland, bone, gallbladder, lymphatic metastasis to the hilar lymph nodes, peripancreatic lymph nodes, Gastric lymph nodes, aortic lymph nodes, supraclavicular lymph nodes, and direct violations to neighboring organs. In the surgical treatment of radiotherapy and chemotherapy of the treatment of anti-injury treatment, the recovery functional treatment is not contributed to the overall treatment of the whole treatment with radiotherapy and chemotherapy in the same lesion, does not have symmetry and integrity, during the transfer of liver cancer only palliative treatment can be adopted, hut there is no cure possibility. Here the recovery function and surgery combined with chemotherapy were described as below separately.

\textcircled{1} Recovery Functional Therapy Combined with Surgery.

The prior art surgery has not been combined with symmetrical recovery function therapy in the course of treatment, and there is a wrong treatment direction. This is the root cause of recurrence and metastasis after surgical treatment. The scope of the operation and the intensity of action should follow the correct treatment direction, in accordance with the principle of the overall treatment to ensure the scope and treatment efforts of the recovery function therapy, and use symmetry equivalent of surgical anti-injury treatment and recovery functional to promote the overall treatment of liver cancer metastasis, thus to prevent recurrence of metastatic metastasis and rehabilitation of the treatment goals, rather than relying on surgery part of the treatment.

Within the first 3-5 days of the operation, the present application adopts the oxygen level horizontal stretching exercise and the Whole body medicine massage, the oral Chinese medicine, and medicine massage, the oral traditional Chinese medicine is the medicine which can strengthen spleen and benefit qi, such as Buzhong Yiqi Decoction, Decoction of Four Mild Drugs, Rehmanniae Decoction of Six Ingredients and so on. Recovery function-based treatment can protect and improve liver function and systemic function, is conducive to surgery to proceed smoothly.

\textcircled{2} Recovery Function-Based Therapy Combined with Radiotherapy.

Radiotherapy in the prior art has no symmetrical recovery function-based therapy in the treatment, lack of treatment of integrity. It is largely impossible to achieve therapeutic goals through quantitative changes, and this is evidenced by the results of most radiotherapy patients. The contents of this paragraph have been discussed in detail in the “cancer diffusion transfer therapy device”, since the present application can perform the positioning recovery function, before 5-10 minutes of the prior art radiotherapy, coat the primary liver cancer and bone, adrenal gland, lymph nodes and other metastatic lesions of the radiotherapy site with external drugs for promoting blood circulation and removing blood stasis (such as active oil, safflower oil, etc.), use handheld massage to take a recovery function-based drug massage for 1-3 minutes, combine extrusion friction with ultrasonic waves and the force can reach the deep visceral tissue and bone surface, and then with several minutes of radiation therapy, the purpose is to increase the sensitivity and intensity of radiotherapy. 5 minutes after the end of radiotherapy, use hand-held massager to coat the drugs for promoting blood circulation and removing blood stasis at the center of the radiotherapy center (such as Astragalus, Codonopsis, Atractylodes, Poria, Magnolia Obavata, Costustoot, Fructus Akebiae), and then with a 3 minutes of drug massage to restore functional treatment, the purpose is to protect the normal cell recovery function and reduce radiotherapy side effects. For the greater side effects of systemic discomfort, the oxygen level stretching exercise and systemic drug massage and oral Chinese medicine can be carried out, and the use of drugs vary from person to time and need to be determined according to the situation and demand.

\textcircled{3} The Importance of Recovery Function-Based Therapy Combined with Chemotherapy

There are many ways of chemotherapy in the prior art, (1) oral; (2) intramuscular injection; (3) intravenous injection; (4) venous shock; (5) intravenous infusion; (6) arterial injection; (7) intracavitary injection; (8) intrathecal injection; (9) intratumoral injection (10) topical application. At present in the cancer chemotherapy, no matter how people update the chemotherapy drugs, how to increase the dose of elongated course of treatment, how to change the drug route, or combination of various chemical compatibility applications. Besides a small number of cancer treatment has improved, the present situation of the long-term efficacy of patients with cancer and five-year survival rate cannot be improved very effectively, and drug resistance of cancer leads 90% of treatment of metastatic cancer to failure. In accordance with the laws of nature, the human body is the unity of structure and function as the unity of the whole, life movement is a combination of physical and chemical high-level form of movement, every step of material metabolism are accompanied by energy transfer. Cancer primary lesions, metastatic lesions are the overall lesion controlled by the structural lesions and functional lesions, physical lesions and chemical lesions. When the patients are in the overall disease and a critical period of life threat, the existing technology using structural anti-injury part of the main treatment and single chemical primary treatment technology, has no possibility of success.

\textcircled{4} Recovery Function-Based Therapy Combined with Systemic Chemotherapy.

Usually chemotherapy is intravenous, also known as systemic chemotherapy, and there is a poor efficacy and side effects of large deficiencies. In systemic chemotherapy, among 95% of drugs of intravenous infusion into the body only 5% can really reach the tumor lesions, but the critical parts of the lesion did not get targeted treatment, which leads to poor efficacy and produces a huge side effect. In the hand-held massager of the present application, the combination of the extrusion and the transdermal drug can be combined with the ultrasonic transdermal drug, and the chemical substance (e.g., topical fluorouracil or the like) having a molecular weight of 5000 or the like can be introduced into the deep tissue through the skin stratum corneum, and input mechanical energy, heat through the body surface to improve microcirculation, recovery function, the primary cancer lesions and metastatic lesions for local holistic treatment. The invented hand-held massager can be applied to coat the whole body the topical Chinese Medicine such as strengthening spleen and invigorating qi and blood circulation, detoxification and the like. Drug selection varies from person to person, take the whole body drug massage, each treatment for 8 minutes, which can eliminate chemotherapy side effect and restore recovery function. The local treatment of the present application and the systemic drug massage therapy can be carried out separately or in combination with systemic chemotherapy, and the treatment is carried out 5 minutes after the end of the intravenous infusion treatment.

\textcircled{5} Recovery Function-Based Therapy Combined with Local Chemotherapy

Local chemotherapy in the transcatheter arterial chemoembolization (TACE) is the first choice for domestic non-surgical therapy, but because of chemotherapy cytotoxicity and some patients with severe cirrhosis, portal hypertension, interventional therapy it is difficult to implement interventional therapy for a long-term. And that liver cancer invasion of intrahepatic blood vessels cause intrahepatic dissemination is still the main reason for the recurrence and metastasis. Functional lesions and physical lesions control the efficacy of chemical drugs and produce resistance. Chemotherapy alone only changes the route of administration, but cannot significantly improve the tumor chemotherapy effect, even with the embolic agent in combination, the effect has been improved but also limited. Chemotherapy can cure the tumor, mainly depends on whether the tumor is sensitive to chemotherapy, does not produce resistance, so in the process of chemotherapy, using physical technology to proceed the symmetry recovery function-based therapy on the lesion site of cancer cells and lesions around the site, is the correct way to enhance the sensitivity of chemotherapy, eliminate drug resistance, increase the effectiveness of cancer cells and reduce the side effects. The overall treatment process is as follows: After the treatment of the transcatheter arterial chemoembolization (TACE), coat the external drugs for promoting circulation and removing stasis in the treatment of lesion site, and use a local therapy device for 1-3 minutes of treatment, improving the microcirculation of the lesion, promoting the absorption of drugs, and then coat external drugs for strengthening spleen and invigorating qi to the lesion treatment area and the larger area around it, use hand-held massager for 3 minutes massage to achieve the purpose of recovery function. For the transfer of lesions, injection within the tumor can be used, and recovery function is same with above method.

In the prior art systemic chemotherapy and local chemotherapy, due to the lack of functional recovery therapy, chemotherapy needs one week, rest for two weeks. Each medication and subsequent withdrawal period both need a course of treatment, generally total 4-6 course of treatment, the total time to be months, with the aim to restore the function of normal cells, to accumulate strength to cope with the upcoming next chemotherapy, this negative waiting significantly reduces the intensity of treatment, and will miss the best treatment time, which is the reason of limited chemotherapy efficacy and even the deaths of patients. And in the overall treatment, protection and recovery of normal cell function in the course of chemotherapy has been completed; the basis of the patient's metabolic function is protected, without this negative wait, and continuous treatment can produce significant efficacy, the patient will not die in the overall treatment process.

In accordance with the principles of traditional Chinese medicine treatment: “outside the rule that is the rule of governance, the treatment of foreign medicine that is the medicine,” the application is characterized in that the hand-held massager restoring function is inseparable from the systemic chemotherapy and the local chemotherapy synchronicity, which leads to the failure of the treatment if separation. Regardless of which chemotherapy method is used, it is important to perform symmetrical recovery therapy at the same time to ensure that the treatment is correctly achieved.

2. Digestive System Recovery Function-Based Therapy as Adjuvant Therapy.

In the surgical treatment of radiotherapy after the end of the recovery function of adjuvant therapy, mainly proceed the overall recovery of traditional Chinese medicine treatment methods, including qigong and Chinese medicine, acupuncture and moxibustion which is the three treasures in the history of Chinese medicine, the common features of qigong are: breathing adjustment, body activities and self-massage. In the application, the abdomen and the systemic medicine massage, the local skin transdermal administration, the horizontal stretching exercise is external treatment method, and the oral medicine is the inner medicine method. Traditional Chinese Medicine states that: outside treatment can be parallel with the internal treatment, and can fill the shortcoming of the internal treatment.” Internal treatment combined with external treatment, can significantly improve the efficacy and be taken for long-term.

Traditional Chinese Medicine treatment of liver cancer is starting from the whole situation, there are cancer, righting, the symptoms can be improved significantly with less adverse reactions, although the effect is slow, but more lasting characteristics. Its elimination of small role in tumor lesions, poor targeting and other shortcomings, gets it as the adjuvant therapy for other treatment at most time. Chinese Medicine uses the two methods of attacking cancer cells and making up, commonly using blood circulation, detoxification in the attack treatment, using Spleen, Liver and kidney, qi and blood and other remedial solidification in the make-up treatment, and which varies from different person. The present application is based on the following reference materials to draw a “normalized treatment plan for liver cancer”, reference books: “new concepts and new methods of cancer metastasis therapy” XuZe with the People's Medical Publishing House in January 2006 first edition 221 pages, 223 pages. “Said lung cancer” Zhang Jinghui and other editor, Hunan Science and Technology Press, December 2012 first edition 58 pages.

VI. The Structural Features and Features of the Present Application.

In the present application, the recovery function of the crawling movement is combined with the recovery of the heart and lung function of the swimming exercise, and the whole function of the body is restored by promoting the whole action to each other. If only one of the exercises is carried out, the whole function cannot be produced. For the whole body function, abdominal digestive function and chest heart and lung function is interdependent but as a whole, the lack of a part of it will lose the overall function.

1. According to the present application, the transmission device for driving the front wheel in the prior art by the supine position pedal is changed to the tilting position pedal wheel to drive the front wheel drive device, thus becoming a human instinct to crawl action, suitable for the recovery of the whole body needs; In the arm strokes installed two wheels, by driving the arms of the rotation or a small arm with a small round swing combined with the legs into a swimming action, can receive the recovery of body function; In the prone level exercise, use the abdominal drug massage device to treat abdominal digestive function lesions, and use hand massage to take a drug massage to the body, so as to achieve the goal of recovery of systemic function.

2. The application has two kinds of movements includes crawling and swimming in the horizontal movement, wherein the crawling movement is the effect of the double arm and the legs being alternately with each other, the strength is low, suitable for each 10 minutes long movement, with a strong effect on abdominal visceral digestive function, can promote the abdominal digestive organs to take shrink and relax “massage” exercise. Swimming is a pair of arms symmetrical ring rotation and legs side by side role, high strength, suitable for a short time movement, each 5 minutes, in the operation of the pedal bar through the fixed connection with the other side of the pedal to adjust to the same turn the direction, you can carry forward the legs before and after the movement. Swimming movement in the arms of symmetrical circular rotation is the expansion of the chest movement, which can squeeze and relax the heart and the lungs, improve heart activity and chest breathing, can improve heart and lung function. During crawling and swimming movement, the leg action force is greater, you can add speed motor to help, and the arm action force is too small to help.

A hand-held massager is used to the whole body massage, and a hand-held massager is a “cancer treatment device” (National Application Patent ZL200610069987.8, Japanese Patent Laid-Open No. 5047301) of the prior art. Hand-held massager are equipped with a DC cut into the friction head, low frequency static friction head, magnetic friction head, friction cloth, with friction heat, according to rub muscle, transdermal drug, electrotherapy, magnetic therapy with effect in the local area within 8 seconds, 8 minutes to complete the body drug massage, suitable for treatment in all parts of the body, through the delivery of heat, mechanical energy, energy, magnetic energy and chemical energy to restore functional treatment. Hand-held massager in the friction head rotating high speed of 2000 r/min, low speed of 500 r/min; friction head pressure at 0.25 kg-0.5 kg/square meter is suitable for friction and heat, transdermal drug, acupuncture treatment, at 0.5 kg-2 kg/square meter it is suitable for the kneading muscles, soft tissue, the force at 3 kg-5 kg/cm can reach the depth of tissue and bone surface; high-speed rotation within 5 seconds can heat the skin to 50° C.-60° C.

4. Treatment Work Principle and Characteristics.

In the stage of cancer metastasis, the killing of cancer cells is the main treatment of the existing chemotherapy technology, the recovery function-based therapy uses hand-held massager and surgery combined with radiotherapy and chemotherapy. Before radiotherapy, it is necessary to take recovery-based function therapy to the radiotherapy site firstly, each for 1-2 minutes, and then radiotherapy. In the interventional chemotherapy, firstly take the interventional chemotherapy, after the end of interventional chemotherapy, use hand-held massager at the intervention site (such as drugs when the tumor is aimed at the tumor) to restore functional treatment for 1-2 minutes each time. In systemic chemotherapy, you can take the whole body massage after the end of chemotherapy with a hand-held massager to restore the recovery function, each for 5 minutes, you can also use traditional Chinese medicine to supplement the energy of the body massage, the same is 5 minutes each time. If you do not carry out auxiliary recovery-based function therapy, killing cancer-based treatment cannot be sustained due to lack of symmetry stability of side effects, and only transient treatment can be carried out, but not the long-term treatment. In the cancer metastasis of patients with death stage, combine the restoration of human body function-based treatment with the radiotherapy and chemotherapy to kill cancer cells. Compared with the eradication of cancer-based treatment, the eradication of cancer cell adjuvant therapy should significantly reduce the killing of cancer cells, the scope of action and increase the mode of action, such as low-dose chemotherapy, interventional chemotherapy, anti-Medicine, etc., plays a role to stabilize and prevent the metastatic lesions of cancer from recurring. Similarly, if not take killing cancer cells adjuvant therapy, the body's main recovery function will limited by cancer cells and cannot effect for a long time due to lack of symmetry stability, and ultimately lead to treatment failure.

VII. Contrast with the Prior Art.

1. In the treatment of cancer metastasis, structural treatment is interdependence with functional treatment and makes effects together, in line with the laws of nature, suitable for rehabilitation of patients survived. In the prior art, structural treatment and functional therapy are separated from each other, and their respective effects can only produce a certain number of changes, cannot produce the overall nature of change, does not meet the laws of nature, and ultimately lead to death.

2. The prior art in the stage of cancer metastasis lesions, use surgical chemotherapy to kill cancer-based treatment as the main treatment, however, in the stage of death of cancer patients, the systemic functional lesions have become the main factors of death, the existing treatment is still the same, do not take the recovery-based function therapy as the main treatment, and there is the primary and secondary reversal treatment with wrong targets. The present application overcomes this deficiency by using a recovery-based function therapy in the stage of death of cancer metastasis patients.

3. Prone position in the movement including the crawling action, swimming action is the survival of human instincts, in line with human structural design requirements, is the basis to save the lives of patients. The existing medical sports crawling and swimming, with the features of exercise a long time, consumption of physical strength, low efficiency, time-consuming and slow laborious effect, cannot meet the needs of patients in the critical stage of treatment. The application is quick and effective in 8 minutes to complete the recovery of systemic functional treatment, significantly improve the effect to meet the treatment needs.

4. The existing technology supine horizontal exercise, the drug massage through the back, cannot produce direct treatment of abdominal digestive function; the drug massage through the abdomen, will have side effects on the abdominal. digestive organs of cancer metastasis tissue, so cannot be applied. In the prone level movement, the medicament massage is carried out under the abdomen, and the abdominal medicine massage not only reduces the pressing side effect due to the relaxation of the abdominal viscera and the internal massage, and the combination of the internal and external massage improves the therapeutic effect remarkably.

VIII. Conclusion

The essay studies the philosophical theory where natural laws guide the treatment, the starting point of its own development is the integrity of the opposition and unity. Integrity is the essence of things, regardless of which part of it is externally active, it reacts as a whole, with each element does not have the nature and function alone, the understanding of the overall concept of disease is different, leading to differences in treatment direction and treatment results. Modern science understands the whole world as a large hierarchical sequence: Earth-Biosphere-Society-Man-System-Organ-Organization-Cell-Molecule-Atom-Basic Particles. There is a leap from quantitative to qualitative change between the upper and lower levels of the hierarchy, and the human disease research object is placed in its inherent hierarchical sequence, and the state and change are examined and adjusted from the two-way interaction between the upper and lower levels. But the above-mentioned hierarchical sequence is the material composition level, not the material movement level, can not reflect the symmetrical interaction between structure and function, the basic law of nature is to maintain symmetry, from macro to micro, from the generation of the universe to each micro Sub-nuclear reaction, applicable to all natural phenomena. The body's anatomical state, physiological function, disease generation and development process has a strong hierarchical structure. Modern medicine lacks a hierarchical understanding of human body function. There is no hierarchical sequence of human physiological function in the above-mentioned material hierarchy. The hierarchical sequence of the structural part of the human anatomical state cannot reflect the interaction between the internal and the level of the hierarchy and the whole action of the structure and function in the life movement, can not determine the cause of the disease, understand the development trend of the disease process and determine the correct treatment direction.

In the prior art, structural treatment and functional therapy are two different properties, different treatment sites of the disease. Traditional Chinese medicine based on ancient Chinese philosophy is to study the human body as a whole, to be good at comprehensive grasp of their laws and to restore functional treatment, and symbolize them (Yin/Yang, inside/outside, etc.); Modern medicine based on modern science (Western medicine) is the decomposition of the human body into the system-organ-cells-molecules, good at changing from these units to infer the state of the body and the substantive structural treatment. The author of the book “Chinese and Western medicine differences and blending,” Zhushi Na said: “to promote Chinese and Western medicine in the field of pathology to unity, the key is the relationship between structural lesions and functional lesions, but also a good problem that the entire pathology research has not yet solved”. In the “Schematic Diagram of the Generation and Development of Hepatocellular Carcinoma”, the “Principles and Techniques for the Treatment of Hepatocellular Carcinoma” and “Schematic Diagram of the Change of Death Causes and Death in Cancer Patients”, the philosophical factors of Chinese medicine and the scientific factors of western medicine are combined into a whole, and the relationship between human anatomy, physiological function, the level of disease generation and development and the interaction between them are described in detail, which is the internal structure of the main function of the auxiliary function of self-interaction self-movement, and the level of function is the main structure of the interaction between the auxiliary movement, is a holistic comprehensive picture of the disease. In the “diagram”, the structure and function have their own independent characteristics and location, the two sides of the differences and contact objectively displayed, each stage of liver cancer metastases is placed in its inherent hierarchical sequence, and the state changes can be examined and adjusted from the two-way interaction between the upper and the next, disease development and development process are in accordance with the light to heavy, from low to high level to the order of the process of change, while the treatment direction is the reverse development process. Structure-based changes and function-based changes in two different forms of disease, depending on the nature of the disease, exist in the process of each disease development stage.

In the “diagram”, the functional level in Chinese medicine is symmetrical and unified with the structural hierarchy of modern medicine in the level of life material, which is a general understanding for the nature of cancer metastasis, and determines the prevention and treatment of cancer metastasis principles and measures. Treatment of cancer and major diseases can be properly worked out only from the level of life and the level of interaction, once their root causes are revealed, its prevention and treatment will become possible and relatively easy. The relationship between structure and function of life is a matter of philosophy and science. When they are clear at all levels, they can be summarized as follows: the structure is the spatial sequence of each level, and the function is the movement sequence at all levels and layers. The two sides are the relationship between the material composition and the interdependence of the material movement. The combination of philosophy and science as a whole based on the overall treatment model, can lead to the establishment of a new pathology basic theory. Chinese medicine as a recovery-based function therapy, should be the main method to reduce the mortality of patients in the treatment of cancer metastasis, and enter the leading position of medical development in the future, according to the law of the relationship between function and structure. As the famous scientist QIAN Xuesen said: “Chinese medicine theory contains a lot of system theory, and this is a serious shortage of Western medicine, Chinese medicine modernization is the right path of medical development, not only will promote the development of medicine, and eventually lead to the transformation of science and technology system-scientific revolution”. (See “Differences and blending of Chinese and Western medicine” Zhu Shiren People's Health Publishing House November 2001 edition 236 pages.)

The fact that the evolution of the human body shows that science is endless and that understanding is impossible. The all results that medical development made, are only a short stage of human cognition history about their life, and any stagnant view is wrong.

### BRIEF DESCRIPTION OF THE DRAWINGS

FIG. 1 illustrates a front view of a liver cancer metastasis therapy device according to the present application;

FIG. 2 illustrates a top view of the applicator shown in FIG. 1;

FIG. 3 illustrates a hand-held massager;

FIG. 4 illustrates a “liver cancer metastasis and development of the schematic diagram”;

FIG. 5 illustrates “liver cancer metastasis therapy principle and technical diagram”;

FIG. 6 illustrates “cancer metastasis patients with death and death caused by the process of changes in the diagram”;

FIG. 7 illustrates “normalized treatment of liver cancer model”.

### DETAILED DESCRIPTION OF THE PREFERRED EMBODIMENT

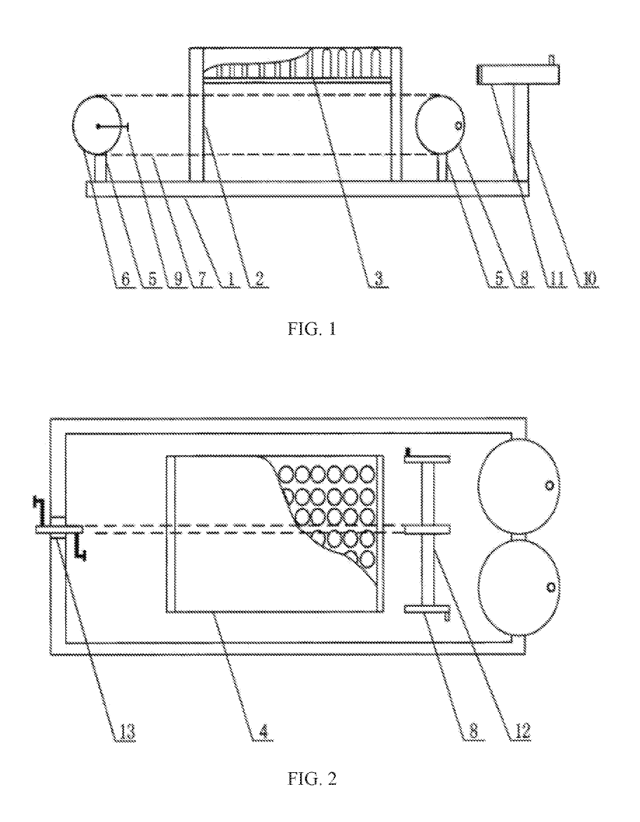

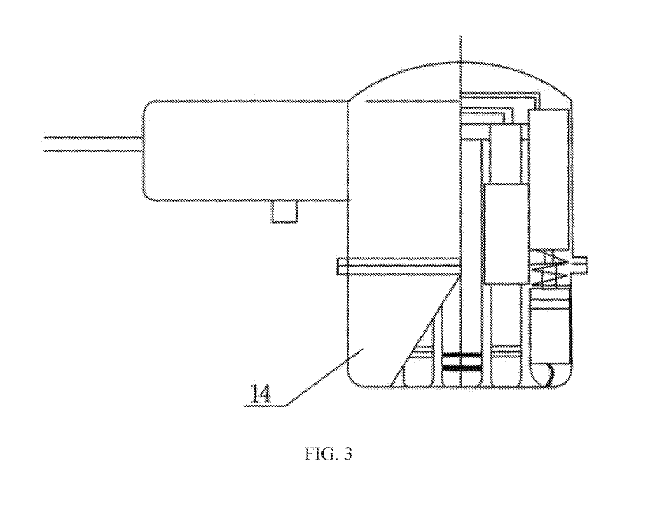

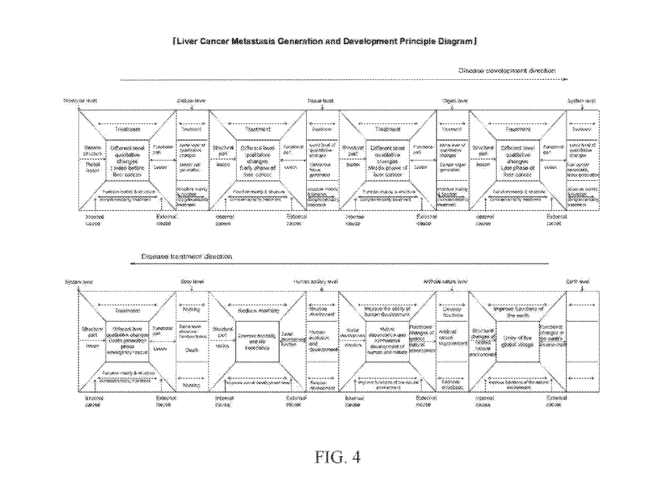

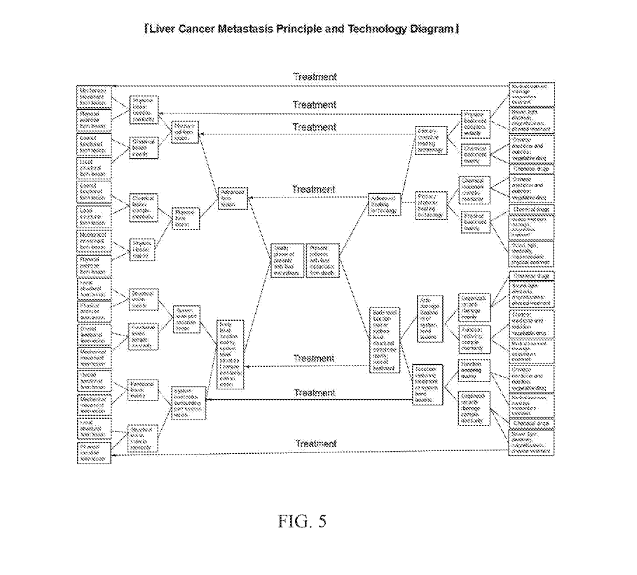

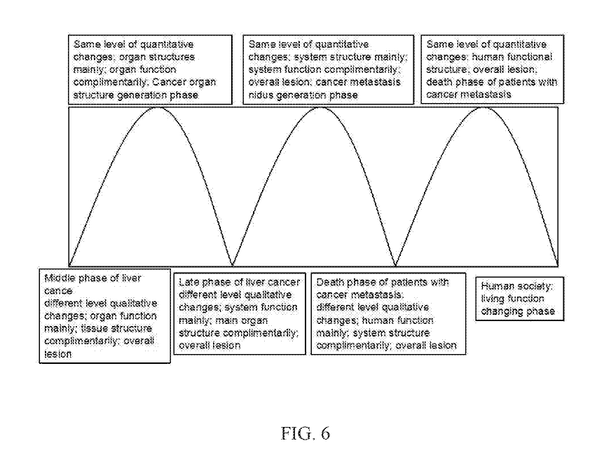

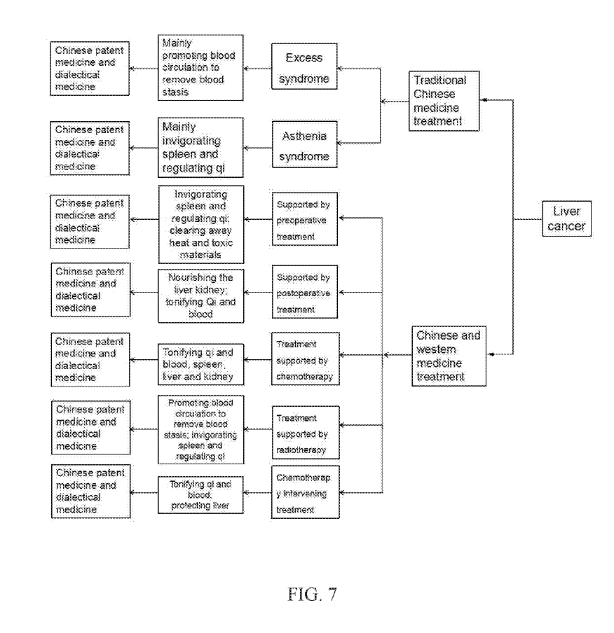

FIG. 1 shows a liver cancer metastasis therapy device: 1 is the pad; 2 is the prone bracket; 3 is the abdominal massager; 5 is the sprocket bracket; 6 is the sprocket; 7 is the chain, 8 is the rotating plate; 9 is the pedal 10 is the runner support and 11 is the runner. FIG. 2 shows the liver metastases in the treatment device: 4 is the drug cloth; 8 is the rotating disk; 12 is the drive shaft; 13 is the speed motor. FIG. 3: 14 shows the hand-held massager.

The present application is achieved by the following technical measures: a hepatocellular metastasis therapy device comprising a plate, a tilting stent, a abdominal massager, a medicine cloth, a sprocket support, a drive shaft, a sprocket, a chain, a rotating disk, a pedal, Wheel support, runner, speed motor, hand-held massager device, to restore the body's body-based treatment, combined with chemotherapy and chemotherapy to kill cancer cells combined treatment of liver cancer metastasis; Characteristic: the tilting bracket (2) is fixedly mounted in the middle of the plate (1), the abdomen massager (3) covered with the medicine cloth (4) is arranged on the top bracket (2), and the sprocket bracket (5) (12) and a sprocket (6) are arranged on the plate (1), the rotating disc (8) is fixed at both ends of the drive shaft (12), the sprocket (6) and the chain (7) The reel bracket (10) is fixed on both sides of the front center of the backing plate (1), and the runner (11) is mounted on it. The patient is prone to power massage on the abdomen massager (3), the patient holding the rotating lever (8), the foot is fixed by the pedal (9), and the speed hoisting motor (13) is rotated by rotating the chain (7), so that the passive crawling movement can be carried out, do not open the motor can be active crawling movement, without chain drive before the arm can be a small swing action, release the grip plate (8) hand, hold the runner (11) hand to rotate, you can swim sports. After exercise, use hand massage (14) by the patient or the doctor for systemic drug massage, supplement the transport of mechanical energy, heat, chemical energy.

Treatment specific steps are as follows:

According to the “liver cancer metastasis and development of the schematic diagram” in the metastatic stage of liver cancer, firstly use hand-held massager and radiotherapy combined with surgery as a whole, take a recovery-based function treatment supplemented by the overall treatment to kill cancer in the liver metastases and around the site. Stable and control the transfer of lesions, in the stage of death of liver cancer metastasis, use prone level movement, abdominal massage and hand massage into a whole, take a recovery-based function treatment supplemented by the overall treatment on the digestive function of the lesion and related circulation, respiratory, immune, neurological and other functional decline in the body to prevent the emergence of systemic functional lesions and prevent death.

1. Recovery Function Combined with Radiotherapy

5 minutes before the prior art radiotherapy, in the primary lesion, the radiotherapy site of the metastatic lesion was coated with external medicine for promoting blood circulation and removing blood stasis, and the massage therapy was performed for 1-2 minutes with a hand-held massager and then radiotherapy was performed. 3-5 minutes after the end of radiotherapy, coat the topical drug for strengthening spleen and invigorating qi in the radiotherapy center around the functional decline parts, use hand-held massager to restore the function for 1-2 minutes of drug massage therapy.

2. Recovery Function Combined with Local Chemotherapy.

After the treatment of the catheter hydrazine arterial chemoembolization (TACE), coat the topical drug for promoting circulation and removing stasis in the treatment of lesions site, use handheld massage for 1-2 minutes, improving microcirculation of the lesion, and promoting drug absorption, and then coat the topical drug for strengthening spleen and invigorating qi in the treatment of parts of the lesion around the larger area, use handheld massage for 1-2 minutes of drug massage, to restore the purpose of the function. For the transfer of lesions, the injection within tumor can be used, and the recovery function is same with the above method.

3. Recovery Function Combined with Systemic Chemotherapy.

Within 5 minutes after the end of systemic chemotherapy, patients can be coated with topical drug for strengthening spleen and invigorating qi, promoting circulation and removing stasis and detoxification on the chest and abdomen, waist and limbs, (drug selection varies from person to person) and use the hand-held massager to carry out systemic drug massage, each treatment for 8 minutes, take a restore functional treatment for the elimination of chemotherapy side effects.

Whether the transfer of lesions is to eliminate the control, the condition is aggravated or reduced, cancer metastasis patients or sooner or later will enter the stage of death of liver cancer metastasis, directly face the death of the body function of this death factor. Because at this time the structure of metastatic lesions is in a relatively stable stage, mainly the development is the development of systemic functional disease, it must use the recovery-based function therapy to restore the body function, supplemented by the treatment of killing cancer cells, use a large treatment device that enhances systemic function.

4. Recovery Function Treatment of Liver Cirrhosis, Liver Ascites and Digestive Function, Circulation, Respiratory.

The use of traditional Chinese medicine outside the treatment of liquid with strengthening spleen and invigorating qi, good for liver and kidney, cirrhosis of the cream, water paste, blood circulation, detoxification, western medicine, nitroglycerin, heartache and so on. Apply liquid to the treatment area and use hand-held massager for reciprocating massage. Treatment once a day, each time 1-3 minutes, 15 times for a course of treatment.

5. Recovery Function is Combined with Chemotherapy

The use of prone level movement in the crawling action, swimming movements, abdominal massage and body massage to restore the body function-based treatment, each time a total of 10 minutes, once every other day, while every other day injection of fluorouracil 250 mg, or small dose injection of molecular targeting anticancer drugs. Treatment sequence is the end of chemotherapy after the recovery of functional treatment, the treatment can be long-term.

6. Recovery Function Combined with Drug Injection, Transdermal Administration.

Use aconite injection, polyporus umbellatus polysaccharide, hedyotisdiffusa, methotrexate (MTX) and other points of anti-cancer drug injection, once a day, injection dose, refer to the instructions. In the transfer site, use fluorouracil topical liquid for transdermal drug delivery and massage treatment, once a day, each for 1-3 minutes, 15 days for a course of treatment, liquid composition, refer to the instructions. The adjuvant therapy of killing cancer cells, reduce the intensity of radiotherapy and chemotherapy, increase the number of treatment and treatment, according to the patient recovery function can be taken for long-term.

During the treatment according to the patient's condition, physical and human differences determine the dose used, the level of movement and massage the intensity. During the course of treatment and after treatment, the double test of structure and function was carried out. The structural examination was based on the existing technical standard. The functional test was based on the recovery function and the quality of life.

### EMBODIMENTS OF THE PRESENT APPLICATION

Crawling and swimming is a medical sport with a recovery function, and many cancer patients have a healing effect by using such medical sports. The abdominal massager of the application is a national application patent LZ-98110305.7, which is approved by the Shandong Provincial Food and Drug Administration, and is approved by the Shandong Provincial Drug Administration (No. 2020044), used by Qingdao City Hospital, Qingdao City Hospital, Qingdao City Cancer Hospital, Qingdao Third People's Hospital for many years, proved that the clinical effect is remarkable, welcome by patients (cancer patients). The application adopts the prone level movement device, combines the crawling, swimming medical sports with the abdominal massage, the hand massage and body massage, through the overall role of the body to restore the body function, can significantly improve the existing technology medical sports, massage therapy force to meet the recovery function and rehabilitation needs of cancer patients.

1. A liver cancer metastasis therapeutic device, it consists of the base plate, prone support, abdomen massager, stype, chain wheel support, transmission shaft, chain wheel, chain, rotary disc, pedal, wheel support, wheel, adjustable speed motor and handheld massager, this device can be used in therapy to recover physical functions of whole body, and it can be combined with surgery and chemoradiotherapy to treat liver cancer metastasis, while surgery and chemoradiotherapy are mainly used to kill cancer cells; its features include: the prone support (2) is fixed and installed on the middle of base plate (1), and the abdomen massager (3) covered with stype (4) is installed on the prone support (2); the chain wheel support (5) is fixed and installed on the base plate (1), it is equipped with transmission shaft (12) and chain wheel (6), the transmission shaft (12) is fixed with rotary discs (8) on both sides, and the chain wheel (6) cooperates with the chain (7) for transmission; the wheel support (10) is fixed on the two sides of the front center of base plate (1), and it is installed with wheel (11).

2. A method for using liver cancer metastasis therapeutic device, wherein the patient lies flat on the stomach on the abdomen massager (3), then connect the power supply for medicine message, the patient holds the rotary pole (8), the patient's feet are fixed by the pedals (9), start the adjustable-speed motor (13) rotating chain (7) on the chain wheel support (5), it will make passive crawling movement, without starting the motor, it can make active crawling movement, and without using the front arm of chain drive, it can make small-amplitude swing and crawling movement—loosen the rotary discs (8), grasp the wheel (11) handle for rotation, and it can make swimming movement; after the horizontal (plus) movement is over, the patient or doctor uses the handheld massager (14) to make medicine message over the whole body, supplement and transmit mechanical energy, thermal energy and chemical energy.

3. The method for using liver cancer metastasis therapeutic device according to claim 2, wherein the said handheld massager (14) combines extrusion friction drug delivery with ultrasound transdermal drug delivery, recovering digestion function through crawling movement and recovering cardiopulmonary function through swimming movement alternately, and it can conduct partial and holistic treatment of primary cancer focus and metastasis focus.

4. The method for using liver cancer metastasis therapeutic device according to claim 2, wherein it combines the recovery function and radiotherapy; 5 minutes before radiotherapy, apply external drug promoting blood circulation to remove blood stasis onto the radiotherapy part of primary cancer focus and metastasis focus, use the handheld massager to conduct medicine message for 1-2 minutes as the functional recovery treatment, and then conduct radiotherapy; 3-5 minutes after radiotherapy, apply spleen-nourishing and qi-regulating external medicine on the part with declining functions around the radiotherapy center, and use the handheld massager to conduct medicine message for 1-2 minutes as the functional recovery treatment.

4. (canceled)

5. The method for using liver cancer metastasis therapeutic device according to claim 2, wherein it combines the recovery function and systemic chemotherapy; within 5 minutes after systemic chemotherapy, apply external traditional Chinese medicines that can nourish spleen, regulate qi, promote blood circulation to remove blood stasis and clear away heat and toxic materials onto the chest, abdomen, waist, back and lims of patients, use the handheld massager to conduct whole-body medicine message for 8 minutes, and it can systematically eliminate the side effects of chemotherapy and recover related functions.

6. The method for using liver cancer metastasis therapeutic device according to claim 2, wherein it combines function recovery with treatment of liver cirrhosis, liver ascites and the digestion, circulation and respiratory function lesions; it adopts various external traditional Chinese medicines that can nourish spleen, regulate qi, nourishing the liver and kidney, treat liver cirrhosis, treat effusion, promote blood circulation to remove blood stasis and clear away heat and toxic materials, and western medicine such as nitroglycerin and isosorbide dinitrate, and after applying medicine onto the treatment part, use the handheld massager to conduct medicine message; conduct the treatment once every day, 1-3 minutes each time, and 15 times for a course of treatment.

7. The method for using liver cancer metastasis therapeutic device according to claim 2, wherein it focuses on function recovery, while combining chemotherapy; it adopts the crawling and swimming movement in horizontal movement stomach, abdomen medicine message and whole-body medicine message as the main treatment to recover the functions of whole body, each time 10 minutes, one treatment every other day, also injecting fluorouracil or small dose of molecular targeted anti-tumor agent every other day, the treatment order is to make the function recovery treatment after the chemotherapy, and this treatment method can be conducted on a long-term basis.

8. The method for using liver cancer metastasis therapeutic device according to claim 2, wherein it combines function recovery with medication injection and transdermal drug delivery; it uses acupoint anti-cancer drug injection, once every day; on the metastasis focus part, it uses fluorouracil external medicine for transdermal drug delivery and message treatment, once every day, 1-3 minutes each time, and 15 times for a course of treatment; in addition to the above treatment to kill cancer cells, recovery of whole-body functions is the main treatment; during the adjuvant therapy to kill cancer cell, reduce the chemoradiotherapy intensity, increase the treatment times and courses, and this can be conducted on a long-term basis in accordance with the patient's recovered functions.

9. The method for using liver cancer metastasis therapeutic device according to claim 2, wherein in accordance with the principles of mutual change of quality and quantity and mutual transformation in this application schematic diagram of liver cancer metastasis generation and development principle, there are two different change forms, that is, “structure decides the function” and “function decides the structure”, they can have a leading status alternatively during the lesion development process and play different roles; the structural treatment and function treatment are interdependent and work together, which satisfy the natural rules, and it suits the rehabilitation, recovery and survival and treatment; in accordance with this application schematic diagram of the cause of liver cancer metastasis patient's death and change rule during the death generation process, we can see that the lesion of human body function structure is the main cause of death, and the cancer metastasis focus on system level is the secondary cause of death; in accordance with the problem of current technology that it lacks treatment for function recovery during liver cancer metastasis, which may develop into systemic functional lesion and result in the death of patient, this application combines the base plate, prone support, abdomen massager, chain wheel drive, wheel and handheld massager into a complete device, during the stage of cancer metastasis which might generate focus, and the handheld massager can be combined with the surgery and chemoradiotherapy to provide overall treatment to metastasis focus part and its surrounding area mainly by killing the cancer cells while supplemented by recovering the functions, in this way to control the metastasis focus, alleviate symptom and delay the lesion development; during the stage from liver cancer metastasis to generation of death, current technology only emphasizes treatment while ignoring function recovery, this application focuses on recovering systemic functions while supplemented by killing cancer cells, which can provide holistic therapy in accordance with the cause of death and prevent systemic functional lesion and death of the patient, and it can realize the purpose of significantly reducing the mortality of cancer patients.

10. The method for using liver cancer metastasis therapeutic device according to claim 2, wherein it combines the recovery function and local radiotherapy; after the transcatheter hepatic arterial chemoembolization treatment, apply external drug promoting blood circulation to remove blood stasis onto the treatment focus part, use the handheld massager to conduct medicine message for 1-2 minutes to promote microcirculation of focus and promote absorption of medicine, then, apply massive spleen-nourishing and qi-regulating external medicine on the treatment focus part, and use the handheld massager to conduct medicine message for 1-2 minutes to recover related functions; for metastasis focus, adopt vascular interventional injection for the tumor, and then use the handheld massager to conduct medicine message for 1-2 minutes.
